(19) United States
(12) Patent Application Publication
(10) Pub. No.: US 2020/0310721 A1
(43) Pub. Date: Oct. 1, 2020

(54) IMAGE FORMING APPARATUS THAT FORMS IMAGE OF SOURCE DOCUMENT ON RECORDING SHEET

(71) Applicant: KYOCERA Document Solutions Inc., Osaka (JP)

(72) Inventor: Naoya MIYAJI, Osaka (JP)

(73) Assignee: KYOCERA Document Solutions Inc., Osaka (JP)

(21) Appl. No.: 16/829,688

(22) Filed: Mar. 25, 2020

(30) Foreign Application Priority Data
Mar. 28, 2019 (JP) 2019-063954

(51) Int. Cl. G06F 3/12

(52) U.S. Cl. CPC G06F 3/1259; G06F 3/1211

(57) ABSTRACT

An image forming apparatus includes an image forming device, an operation device, and a control device. The image forming device forms an image on a recording sheet. The operation device receives an instruction inputted by a user. The control device sets a cancellable time upon receipt, via the operation device, of a start instruction to cause the image forming device to start image forming, causes the image forming device to start the image forming, in a case where a cancel instruction to cancel the image forming is not received within the cancellable time via the operation device, and cancels the image forming in a case where the cancel instruction is received within the cancellable time, via the operation device. Further, the control device changes the cancellable time, according to a predetermined condition.

### INCORPORATION BY REFERENCE

This application claims priority to Japanese Patent Application No. 2019-063954 filed on Mar. 28, 2019, the entire contents of which are incorporated by reference herein.

### BACKGROUND

The present disclosure relates to an image forming apparatus that forms an image of a source document on a recording sheet, and more particularly to a technique to cancel an image forming job.

In the case of existing image forming apparatuses, when a user presses a start key an image reading device reads an image of the source document, which is then formed on a recording sheet by an image forming device, and the recording sheet is discharged to a tray. When the user inputs a cancel instruction by pressing a cancel key, after once pressing the start key and before the recording sheet starts to be fed to the image forming device, the image forming job is cancelled.

In the case of another existing image forming apparatus configured to perform test printing of an image to be formed, after one of a plurality of sets of image forming jobs is formed on the recording sheet, the image forming of the remaining sets is temporarily withheld, and when the image forming of the remaining sets is instructed before a confirmation time elapses after the image forming of the first set, the image forming of the remaining sets is started. Further, when the confirmation time has elapsed, without the image forming of the remaining sets having been instructed to execute or cancel, execution of another image forming job than the image forming job thus far executed is permitted. The confirmation time is set to a longer time, in proportion to the number of sheets of the test printing.

### SUMMARY

The disclosure proposes further improvement of the foregoing technique.

In an aspect, the disclosure provides an image forming apparatus including an image forming device, an operation device, and a control device. The image forming device forms an image on a recording sheet. The operation device receives an instruction inputted by a user. The control device sets a cancellable time upon receipt, via the operation device, of a start instruction to cause the image forming device to start image forming, causes the image forming device to start the image forming, in a case where a cancel instruction to cancel the image forming is not received within the cancellable time via the operation device, and cancels the image forming in a case where the cancel instruction is received within the cancellable time, via the operation device. Further, the control device changes the cancellable time, according to a predetermined condition.

### BRIEF DESCRIPTION OF THE DRAWINGS

FIG. 1 is a cross-sectional view of an image forming apparatus according to a first embodiment of the disclosure.

FIG. 2 is a block diagram showing an essential internal configuration of the image forming apparatus.

FIG. 3 is a flowchart showing a process of changing a cancellable time.

FIG. 4 is a schematic drawing showing a confirmation screen displayed on the display device of the image forming apparatus according to the first embodiment.

FIG. 5A is a timing chart showing a relation between a period of preliminary operation and the cancellable time, in the image forming device according to the first embodiment.

FIG. 5B is a timing chart showing a relation between the period of preliminary operation, started at the time point that the cancellable time has ended, and the cancellable time.

FIG. 6 is a flowchart showing a process of changing the cancellable time according to a second embodiment, in which the cancellable time is changed according to the user's age.

FIG. 7 is a schematic drawing showing a confirmation screen displayed on the display device of the image forming apparatus according to the second embodiment.

FIG. 8 is a timing chart showing a relation between the period of preliminary operation and the cancellable time, in the image forming device according to the second embodiment.

FIG. 9 is a flowchart showing a process of changing the cancellable time according to a third embodiment, in which the cancellable time is changed according to a printing charge calculated by a billing device.

FIG. 10 is a flowchart showing a process of changing the cancellable time according to a fourth embodiment, in which the cancellable time is changed according to the number of times of cancellation of image forming jobs.

### DETAILED DESCRIPTION

Hereafter, embodiments of the disclosure will be described, with reference to the drawings.

### First Embodiment

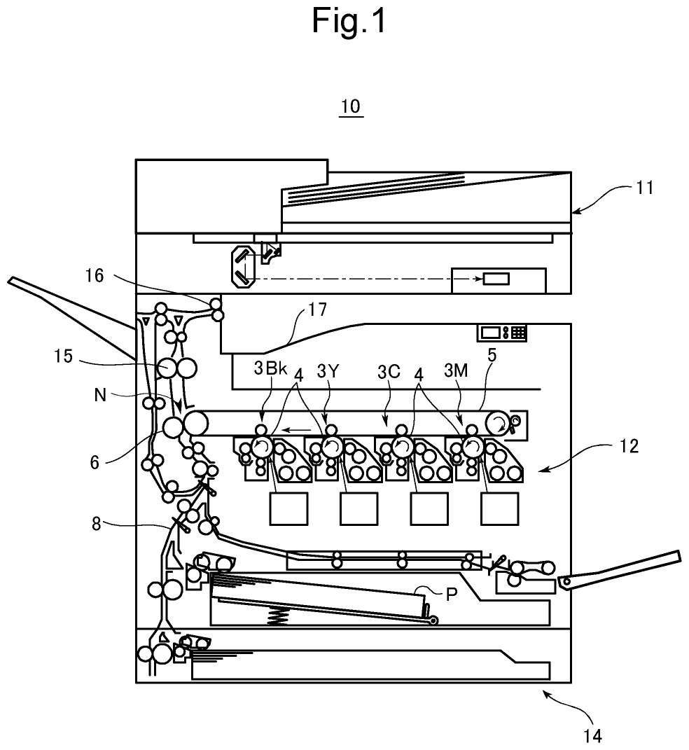

FIG. 1 is a cross-sectional view of an image forming apparatus according to a first embodiment of the disclosure. As shown in FIG. 1, the image forming apparatus 10 according to this embodiment is a multifunction peripheral (MFP) configured to execute a plurality of functions including, for example, a copying function, a printing function, and a facsimile function. The image forming apparatus 10 includes an image reading device 11 and an image forming device 12.

The image reading device 11 includes an image sensor that optically reads an image of the source document, and the analog output from the image sensor is converted into a digital signal, so that image data representing the image of the source document is generated.

The image forming device 12 is configured to print an image represented by the image data on a recording sheet, and includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged, and an electrostatic latent image is formed on the surface of the photoconductor drum 4 by exposure. Then the electrostatic latent image on the surface of the photoconductor drum 4 is developed into a toner image, and the toner image on the photoconductor drum 4 is transferred to an intermediate transfer roller 5 via a primary transfer roller 6. Thus, the color toner image is formed on the intermediate transfer roller 5. The color toner image is transferred to the recording sheet P transported along a transport route 8 from a paper feed device 14, at a nip region N defined between the intermediate transfer roller 5 and a secondary transfer roller 6.

Thereafter, the recording sheet P is press-heated in a fixing device 15, so that the toner image on the recording sheet P is fixed by thermal compression, and then the recording sheet P is discharged to an output tray 17 through a discharge roller 16.

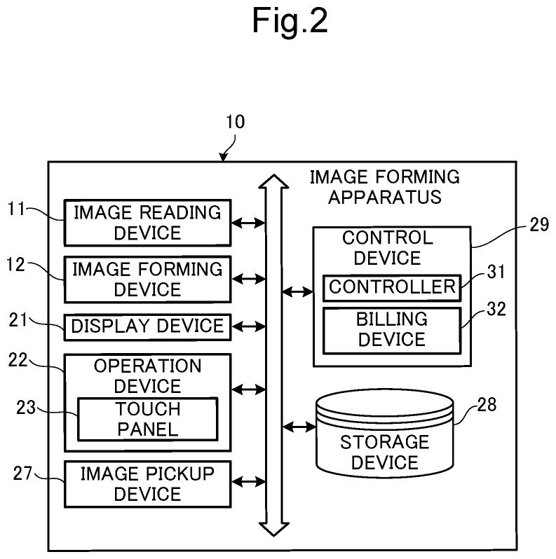

FIG. 2 is a block diagram showing an essential internal configuration of the image forming apparatus 10 according to this embodiment. As shown in FIG. 2, the image forming apparatus 10 according to this embodiment includes the image reading device 11, the image forming device 12, a display device 21, an operation device 22, a touch panel 23, an image pickup device 27, a storage device 28, and a control device 29. The mentioned components are configured to transmit and receive data or signals to and from each other, via a bus.

The display device 21 is, for example, constituted of a liquid crystal display (LCD) or an organic light-emitting diode (OLED) display.

The operation device 22 includes physical keys such as a tenkey, an enter key, and a start key. To the operation device 22, instructions are inputted by the user's operation.

A touch panel 23 is overlaid on the screen of the display device 21. The touch panel 23 is based on a resistive film or electrostatic capacitance, and configured to detect a contact (touch) of the user's finger, along with the touched position, and outputs a detection signal indicating the coordinate of the touched position, to a controller 31 of the control device 29 to be subsequently described. The touch panel 23 constitutes a part of the operation device 22. An instruction inputted by the user by touching the display screen is received by the touch panel 23, which outputs the received instruction to the controller 31.

The image pickup device 27 is a camera including an image sensor and lenses, and shoots the face image of the user using the image forming apparatus 10.

The storage device 28 includes a large-capacity solid state drive (SSD) or a hard disk drive (HDD), and contains various application programs and various types of data.

The control device 29 includes a processor, a random-access memory (RAM), a read-only memory (ROM), and so forth. The processor is, for example, a central processing unit (CPU), a micro processing unit (MPU), or an application specific integrated circuit (ASIC). The control device 29 acts as a controller 31 and a billing device 32, when the processor executes a control program stored in the storage device 28.

The controller 31 executes overall control of the image forming apparatus 10. The control device 29 is connected to the image reading device 11, the image forming device 12, the display device 21, the operation device 22, the touch panel 23, the image pickup device 27, and the storage device 28. The controller 31 controls the operation of the mentioned components, and transmits and receives data and signals to and from each of those components.

The controller 31 serves as a processing device that executes various operations necessary for the image forming to be performed by the image forming apparatus 10. Further, the controller 31 receives operational instructions inputted by the user, in the form of a detection signal outputted from the touch panel 23 of the operation device 22, or through a press of a physical key of the operation device 22. In addition, the controller 31 is configured to control the display operation of the display device 21.

The billing device 32 calculates a printing charge for the printing of the image of the source document, on the basis of, for example, the number of sheets on which the image of the source document is to be recorded, and whether monochrome or color printing is to be performed, and collects the printing charge from the user, for example via a non-illustrated coin vendor.

With the image forming apparatus 10 configured as above, the user may, for example, set a source document on the image reading device 11, and presses the start key of the operation device 22, thereby inputting a copy start instruction. Upon receipt of the copy start instruction inputted through the operation device 22, the controller 31 causes the display device 21 to display a confirmation screen showing information about the image forming. When the user touches an OK key on the confirmation screen of the display device 21, a copy confirmation notice is inputted to the operation device 22, and the controller 31 causes the image reading device 11, upon receipt of the copy confirmation notice, to read the image of the source document according to the copy confirmation notice, and causes the image forming device 12 to form the image of the source document on the recording sheet.

The confirmation screen also includes a cancel key, for the user to input a cancel instruction of the copying operation. The controller 31 can accept, even after receipt of the copy confirmation notice via the operation device 22, the cancel instruction of the copying operation, in accordance with the user's touch operation on the cancel key. The controller 31 cancels the copying operation once approved with the copy confirmation notice, in accordance with the cancel instruction of the copying operation. However, the controller 31 cancels the copying operation in accordance with the cancel instruction, only within a predetermined period of time (cancellable time). The controller 31 changes the cancellable time, according to predetermined conditions.

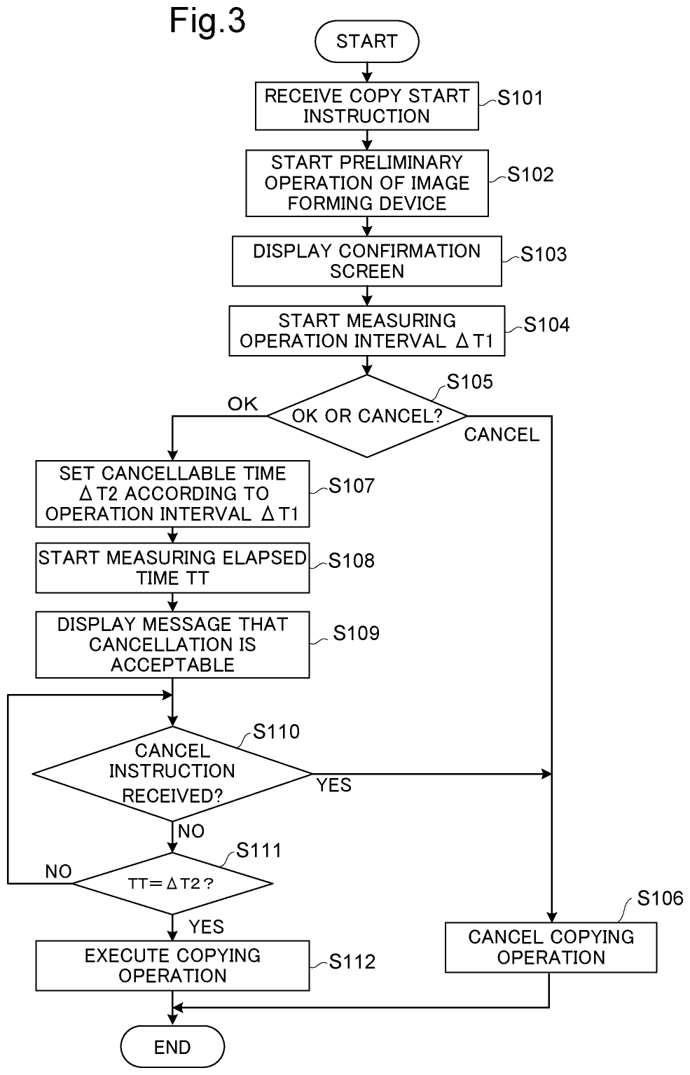

The changing process of the cancellable time will be described in detail, with reference to a flowchart of FIG. 3. FIG. 3 is a flowchart showing the process of changing the cancellable time. Here, the term “copying operation” exemplifies the “image forming” in the disclosure. The term “copy confirmation notice” exemplifies the “confirmation notice” in the disclosure.

First, the user sets a source document on the image reading device 11, and presses the start key of the operation device 22, thereby inputting the copy start instruction. Upon receipt of the copy start instruction via the operation device 22 (S101), the controller 31 causes the image forming device 12 to start a preliminary operation (S102). The preliminary operation includes, for example, image density adjustment (calibration) fir the image forming device 12 and primary paper feed from the paper feed device 14 to a position immediately before the image forming device 12.

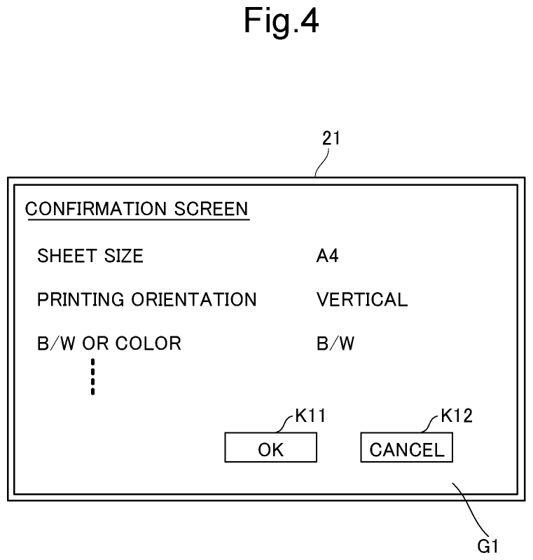

The controller 31 also causes the display device 21 to display a confirmation screen G1 as shown in FIG. 4 (S103), and starts time keeping of an operation interval ΔT1, from a time point TA at which the copy start instruction has been received (S104). The confirmation screen G1 shown in FIG. 4 includes information related to the image forming job, such as the size of the recording sheet, orientation of the image with respect to the recording sheet (vertical or horizontal), and whether monochrome or color, with keys such as an OK key K11 and a cancel key K12.

When the user touches the cancel key K12 (CANCEL at S105), the controller 31 receives the cancel instruction of the copying operation, through the operation device 22. Then the controller 31 suspends the time keeping of the operation interval ΔT1, causes the image reading device 11 to stop reading the image of the source document, and deactivates the image forming device 12, thereby cancelling the copying operation (S106).

When the user touches the OK key K11 (OK at S105), the controller 31 receives the copy confirmation notice through the operation device 22. Then the controller 31 suspends the time keeping of the operation interval ΔT1, acquires the operation interval ΔT1 which is the time from the time point TA at which the copy start instruction was received, to the time point TB at which the copy confirmation notice has been received, and determines a cancellable time ΔT2 on the basis of the operation interval ΔT1 (S107).

For example, when the operation interval ΔT1 is shorter than a predetermined threshold, the controller 31 sets the cancellable time ΔT2 to a predetermined time t11, and when the operation interval ΔT1 is equal to or longer than the threshold, the controller 31 sets the cancellable time ΔT2 to a predetermined time t12 shorter than the predetermined time W. Alternatively, the controller 31 may store a plurality of predetermined thresholds, and when the operation interval ΔT1 is equal to or longer than one of the thresholds, the cancellable time ΔT2 may be set to a time t associated with the longest threshold, among the thresholds shorter than the operation interval ΔT1. Thus, the cancellable time ΔT2 can be set to be shorter, when the operation interval ΔT1 is longer (i.e., the cancellable time ΔT2 is prolonged when the operation interval ΔT1 is shorter). Here, with respect to each of the thresholds, a shorter time is associated with a longer threshold.

The controller 31 starts the time keeping of elapsed time TT from immediately after the receipt of the copy confirmation notice (S108), and causes the display device 21 to display a message to the effect that the cancellation is acceptable, on the confirmation screen G1 (S109). Further, the controller 31 decides whether the cancel instruction has been received (S110), and whether the elapsed time TT has reached the cancellable time ΔT2 (S111).

In the case where the controller 31 receives the cancel instruction (Yes at S110) via the operation device 22 according to the user's touch on cancel key K12, without the elapsed time TT having been decided to have reached the cancellable time ΔT2 (No at S110 and S111), the controller 31 suspends the time keeping of the elapsed time TT, causes the image reading device 11 to stop reading the image of the source document, and deactivates the image forming device 12, thereby cancelling the copying operation (S106).

In the case where the elapsed time TT is decided to have reached the cancellable time ΔT2 (Yes at S111), without the cancel instruction having been received (No at S110), the controller 31 suspends the time keeping of the elapsed time TT, starts the copying operation by causing the image reading device 11 to read the image of the source document, and causes the image forming device 12 to form the image of the source document on the recording sheet (S112).

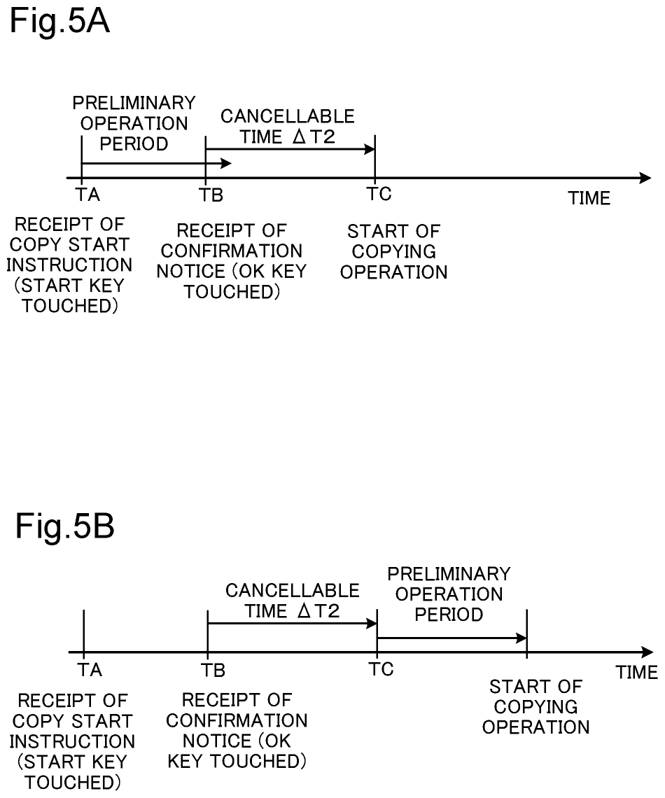

By thus executing the copying operation (S112) through the step of “Yes at S111”, the time before the image forming device 12 becomes ready to perform the image forming can be shortened, since the preliminary operation of the image forming device 12 is already started at S102. For example, it will be assumed that, as shown in FIG. 5A, the copy start instruction is received at the time point TA so that the preliminary operation of the image forming device 12 is started, the copy confirmation notice is received at the time point TB so that the time keeping of the elapsed time TT is started, and the elapsed time TT has reached the cancellable time ΔT2 at the time point TC. In this case, the preliminary operation of the image forming device 12 may be completed before the time point TC, and therefore the image forming device 12 can immediately start the image forming.

In contrast, in the case where, as shown in FIG. 5B, the copy start instruction is received at the time point TA, the copy confirmation notice is received at the time point TB so that the time keeping of the elapsed time TT is started, and the elapsed time TT reaches the cancellable time ΔT2 at the time point TC, and the preliminary operation of the image forming device 12 is started from the time point TC, the start of the image forming is delayed, by the period corresponding to the time necessary for the preliminary operation. Therefore, it is advantageous to start the preliminary operation of the image forming device 12 from S102, as shown in FIG. 5A.

In this embodiment, as described above, when the copy start instruction is received, the confirmation screen G1 showing the information about the image forming is displayed on the display device 21, and when the copy confirmation notice is received thereafter, the operation interval ΔT1, from the time point TA at which the copy start instruction was received, to the time point TB at which the copy confirmation notice has been received, is acquired. The shorter the operation interval ΔT1 is, the longer cancellable time ΔT2 is set. Accordingly, even when the user immediately touches the OK key K11, barely viewing the confirmation screen G1 displaying the information about the image forming, after touching the start key, the user can still touch the cancel key K12 to cancel the image forming after reviewing the confirmation screen G1, since the cancellable time ΔT2 is set to a long period.

In the case of the existing image forming apparatuses, when the user touches the cancel key, after touching the start key and before the recording sheet starts to be fed to the image forming device, the image forming job is cancelled. However, depending on the type of the user, the time after the touch of the start key and before the cancel key becomes no longer valid may be too short, and the user misses the timing to cancel the image forming job, or, on the contrary, the user may feel that the time before the image forming is started is too long, because the time before the cancel key becomes no longer valid is too long.

In the case of another existing image forming apparatus, when the confirmation time has elapsed without the printing of the remaining sets having been instructed to execute or cancel, execution of another image forming job is permitted, and the longer confirmation time is set, the larger number of sheets are to be printed as the test printing. Therefore, although a longer cancellable time is given when a larger number of sheets are to be printed as the test printing, the time after the touch of the start key and before the cancel key becomes invalid is not adjusted.

With the arrangement according to this embodiment, the time after the receipt of the instruction to start the image forming, and before the instruction by the cancel key becomes no longer acceptable, can be changed to a more convenient time for the user.

### Second Embodiment

Hereunder, a second embodiment of the process to change the cancellable time will be described. In the second embodiment, the controller 31 causes the image pickup device 27 to shoot the user's face image, upon receipt of the copy start instruction, to estimate the user's age on the basis of the user's face image that has been shot, and changes the cancellable time according to the user's age. In the second embodiment, the user can cancel the image forming job even after touching the start key thereby inputting the copy start instruction, by touching the cancel key on the confirmation screen of the display device 21 within the cancellable time, thereby inputting the cancel instruction.

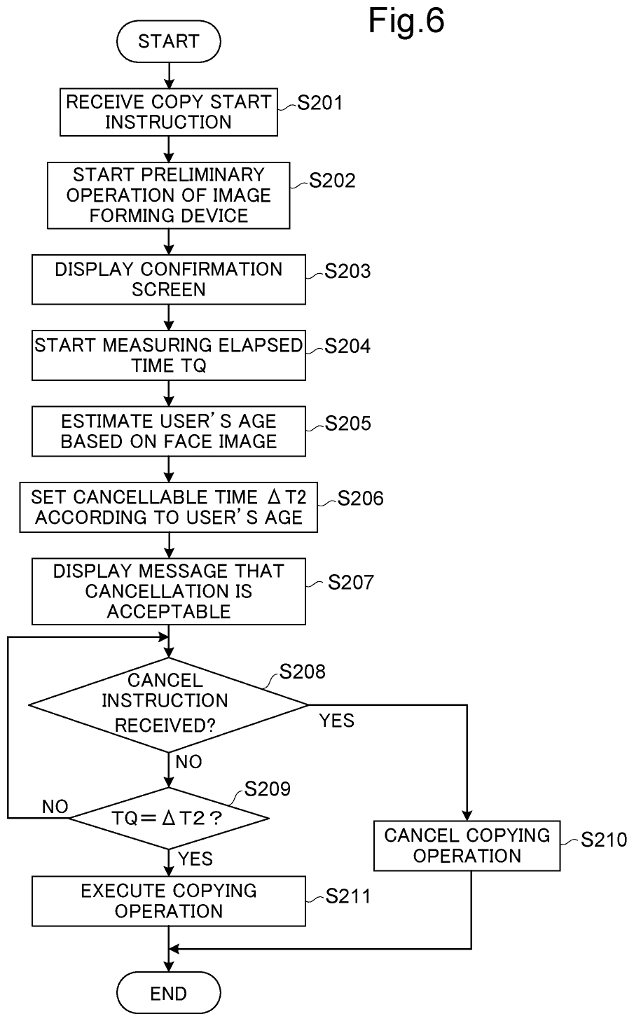

Such a process to estimate the user's age and change the cancellable time on the basis of the user's age will be described in further detail, with reference to the flowchart of FIG. 6.

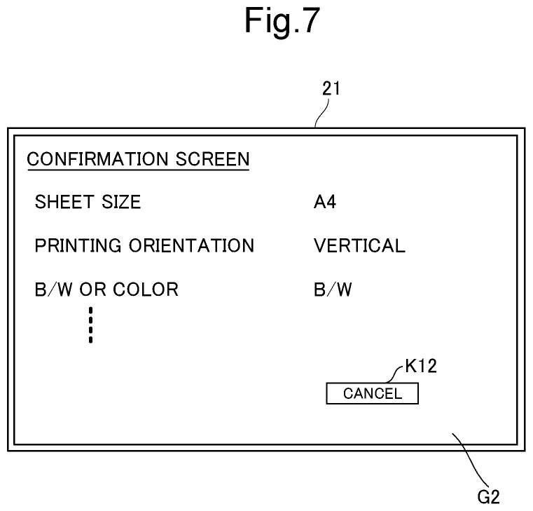

First, the user sets a source document on the image reading device 11, and presses the start key of the operation device 22, thereby inputting the copy start instruction. Upon receipt of the copy start instruction (S201), the controller 31 causes the image forming device 12 to start the preliminary operation (S202). The controller 31 also causes the display device 21 to display a confirmation screen G2 as shown in FIG. 7 (S203), and starts the time keeping of an elapsed time TQ, from the time point TA at which the copy start instruction has been received (S204).

The confirmation screen G2 shown in FIG. 7 includes the information related to the image forming job, such as the size of the recording sheet, orientation of the image with respect to the recording sheet, and whether monochrome or color, with the cancel key K12.

Further, the controller 31 causes the image pickup device 27 to shoot the face image of the user of the image forming apparatus 10, and estimates the user's age on the basis of the user's face image that has been shot (S205). The estimation of age based on the face image is performed with a known method, for example using AI.

The controller 31 then determines the cancellable time ΔT2, according to the user's age estimated as above (S206). For example, when the user's age is lower than a predetermined threshold, the cancellable time ΔT2 is set to a predetermined time t13, and when the user's age is equal to or higher than the threshold, the cancellable time ΔT2 is set to a predetermined time t14, longer than the predetermined time t13. Alternatively, the controller 31 may store a plurality of predetermined thresholds, and when the user's age is equal to or higher than one of the thresholds, the cancellable time ΔT2 may be set to a time t associated with the highest threshold, among the thresholds lower than the user's age. Thus, the cancellable time ΔT2 can be set to be longer, when the user's age is higher (i.e., the cancellable time ΔT2 is shortened when the user's age is lower). Here, with respect to each of the thresholds, a longer time is associated with a higher threshold.

After setting the cancellable time ΔT2, the controller 31 causes the display device 21 to display a message to the effect that the cancellation is acceptable, on the confirmation screen G2 (S207). Further, the controller 31 decides whether the cancel instruction has been received (S208), and also whether the elapsed time TQ, from the time point TA at which the copy start instruction was received, has reached the cancellable time ΔT2 (S209).

In the case where the controller 31 receives the cancel instruction (Yes at S208) via the operation device 22 according to the user's touch on cancel key K12, before the elapsed time TQ reaches the cancellable time ΔT2 (No at S208, No at S209), the controller 31 suspends the time keeping of the elapsed time TQ, causes the image reading device 11 to stop reading the image of the source document, and deactivates the image forming device 12, thereby cancelling the copying operation (S210).

Further, upon deciding that the elapsed time TQ has reached the cancellable time ΔT2 (Yes at S209), without the cancel instruction having been received (No at S208), the controller 31 suspends the time keeping of the elapsed time TQ, starts the copying operation by causing the image reading device 11 to read the image of the source document, and causes the image forming device 12 to form the image of the source document on the recording sheet (S211).

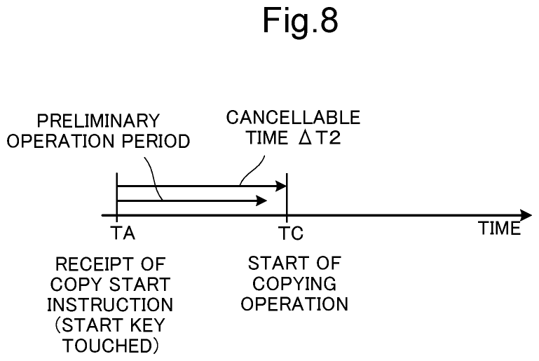

In this case, since the preliminary operation of the image forming device 12 is already started at S202, the time before the image forming device 12 becomes ready to perform the image forming can be shortened. For example, as shown in FIG. 8, the preliminary operation of the image forming device 12 is started, when the copy start instruction is received at the time point TA, and therefore the preliminary operation of the image forming device 12 may be completed by the time point TC, at which the elapsed time TQ reaches the cancellable time ΔT2. In this case, the image forming device 12 can immediately start the image forming.

In this embodiment, as described above, when the user touches the start key of the operation device 22, the user's face image is shot by the image pickup device 27 for estimation of the user's age based on the user's face image, and the longer cancellable time ΔT2 is set, the higher the user's age is estimated to be. Therefore, a user of a higher age can cancel the image forming job, despite touching the cancel key K12 with a certain delay after touching the start key.

Here, different methods may be adopted to estimate the user's age. For example, a card reader for reading the user's ID card may be provided on the image forming apparatus 10. The controller 31 can either read the user's age from the ID card through the card reader, or read the user's date of birth from the ID card and calculate the user's age from the date of birth. The controller 31 can acquire the user's age, from the information thus obtained.

### Third Embodiment

Hereunder, a third embodiment of the process to change the cancellable time will be described. In the third embodiment, the controller 31 changes the cancellable time, upon receipt of the copy start instruction, on the basis of a printing charge calculated by the billing device 32. The user can cancel the image forming job even after touching the start key thereby inputting the copy start instruction, by touching the cancel key on the confirmation screen of the display device 21 within the cancellable time, thereby inputting the cancel instruction.

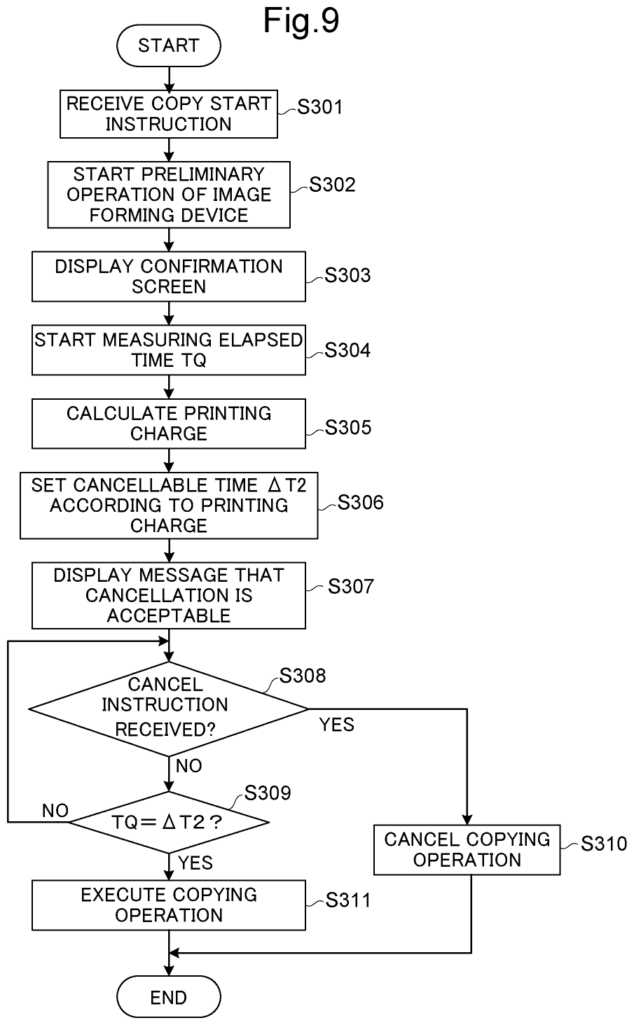

Such a process to change the cancellable time on the basis of the printing charge calculated by the billing device 32 will be described in further detail, with reference to the flowchart of FIG. 9.

First, the user sets a source document on the image reading device 11, and touches the start key of the operation device 22, thereby inputting the copy start instruction. Upon receipt of the copy start instruction (S301), the controller 31 causes the image forming device 12 to start the preliminary operation (S302). The controller 31 also causes the display device 21 to display the confirmation screen G2 as shown in FIG. 7 (S303), and starts the time keeping of the elapsed time TQ, from the time point TA at which the copy start instruction has been received (S304).

The billing device 32 calculates the printing charge for the printing of the source document image, on the basis of, for example, the number of recording sheets on which the source document image is to be recorded, and whether monochrome or color printing is to be performed (S305). The controller 31 acquires the printing charge calculated by the billing device 32, and determines the cancellable time ΔT2 according to the printing charge (S306). For example, when the printing charge is lower than a predetermined threshold, the cancellable time ΔT2 is set to a predetermined time t15, and when the printing charge is equal to or higher than the threshold, the cancellable time ΔT2 is set to a predetermined time t16, longer than the predetermined time t15. Alternatively, the controller 31 may store a plurality of predetermined thresholds, and when the printing charge is equal to or higher than one of the thresholds, the cancellable time ΔT2 may be set to a time t associated with the highest threshold, among the thresholds lower than the printing charge. Thus, the cancellable time ΔT2 can be set to be longer, when the printing charge is higher (i.e., the cancellable time ΔT2 is shortened when the printing charge is lower). Here, with respect to each of the thresholds, a longer time is associated with a higher threshold.

After setting the cancellable time ΔT2, the controller 31 causes the display device 21 to display a message to the effect that the cancellation is acceptable, on the confirmation screen G2 (S307). Further, the controller 31 decides whether the cancel instruction has been received (S308), and also whether the elapsed time TQ, from the time point TA at which the copy start instruction was received, has reached the cancellable time ΔT2 (S309).

In the case where the controller 31 receives the cancel instruction (Yes at S308) before the elapsed time TQ reaches the cancellable time ΔT2 (No at S308, No at S309), the controller 31 suspends the time keeping of the elapsed time TQ, causes the image reading device 11 to stop reading the image of the source document, and deactivates the image forming device 12, thereby cancelling the copying operation (S310).

Further, upon deciding that the elapsed time TQ has reached the cancellable time ΔT2 (Yes at S309), without the cancel instruction having been received (No at S308), the controller 31 suspends the time keeping of the elapsed time TQ, starts the copying operation by causing the image reading device 11 to read the image of the source document, and causes the image forming device 12 to form the image of the source document on the recording sheet (S311). In this case, since the preliminary operation of the image forming device 12 is already started at S302, the time before the image forming device 12 becomes ready to perform the image forming can be shortened.

In this embodiment, as described above, when the user touches the start key of the operation device 22, the printing charge is calculated, and the longer cancellable time ΔT2 is set, the higher the printing charge is. Therefore, when the printing charge is high, the user can cancel the image forming job, despite touching the cancel key K12 with a certain delay after touching the start key.

### Fourth Embodiment

Hereunder, a fourth embodiment of the process to change the cancellable time will be described. In the image forming apparatus 10 according to the fourth embodiment, the controller 31 stores the number of times of cancellation of the image forming job, and adjusts the cancellable time according to the number of times of cancellation. The user can cancel the image forming job even after touching the start key, by touching the cancel key on the confirmation screen of the display device 21 within the cancellable time.

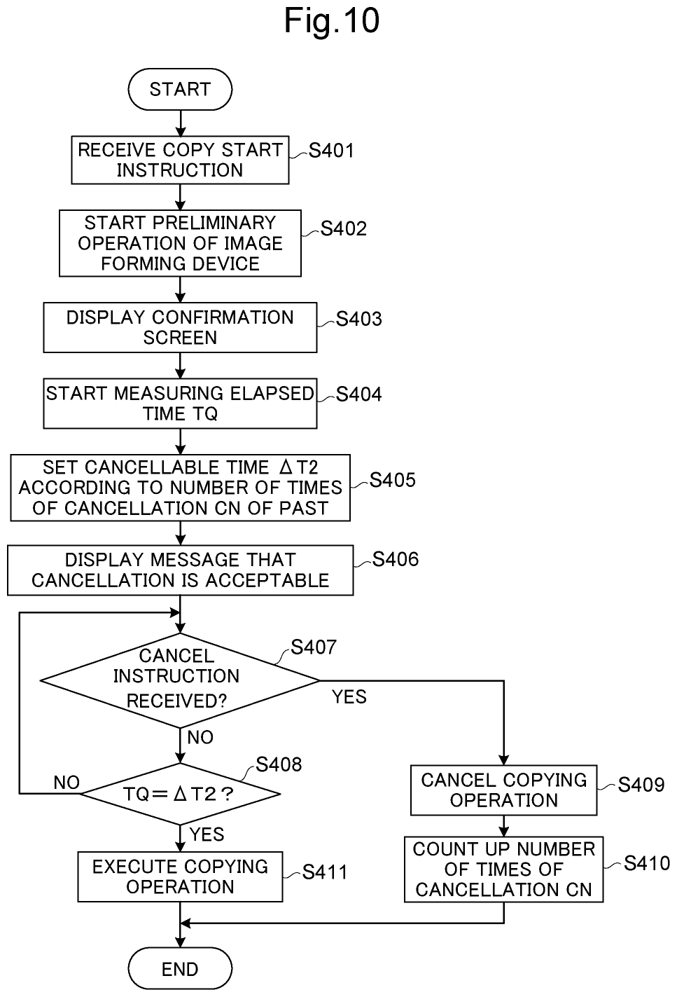

Such a process to change the cancellable time on the basis of the number of times of cancellation of the image forming job will be described in further detail, with reference to the flowchart of FIG. 10.

First, the user sets a source document on the image reading device 11, and touches the start key of the operation device 22, thereby inputting the copy start instruction. Upon receipt of the copy start instruction (S401), the controller 31 causes the image forming device 12 to start the preliminary operation (S402). The controller 31 also causes the display device 21 to display the confirmation screen G2 as shown in FIG. 7 (S403), and starts the time keeping of the elapsed time TQ, from the time point TA at which the copy start instruction has been received (S404).

The controller 31 reads out, from the storage device 28, the number of times of cancellation CN that happened before the current copying operation, and determines the cancellable time ΔT2 according to the number of times of cancellation CN (S405). For example, when the number of times of cancellation CN is less than a predetermined threshold, the cancellable time ΔT2 is set to a predetermined time t17, and when the number of times of cancellation CN is equal to or larger than the threshold, the cancellable time ΔT2 is set to a predetermined time t18, longer than the predetermined time t17. Alternatively, the controller 31 may store a plurality of predetermined thresholds, and when the number of times of cancellation CN is equal to or larger than one of the thresholds, the cancellable time ΔT2 may be set to a time t associated with the largest threshold, among the thresholds less than the number of times of cancellation CN. Thus, the cancellable time ΔT2 can be set to be longer, when the number of times of cancellation CN is larger (i.e., the cancellable time ΔT2 is shortened when the number of times of cancellation CN is less). Here, with respect to each of the thresholds, a longer time is associated with a larger threshold.

As will be subsequently described, the controller 31 counts up the number of times of cancellation CN each time the cancel instruction is received within the cancellable time ΔT2, thereby updating the number of times of cancellation CN stored in the storage device 28.

After setting the cancellable time ΔT2, the controller 31 causes the display device 21 to display a message to the effect that the cancellation is acceptable, on the confirmation screen G2 (S406). Further, the controller 31 decides whether the cancel instruction has been received (S407), and also whether the elapsed time TQ, from the time point TA at which the copy start instruction was received, has reached the cancellable time ΔT2 (S408).

In the case where the controller 31 receives the cancel instruction (Yes at S407) before the elapsed time TQ reaches the cancellable time ΔT2 (No at S407, No at S408), the controller 31 suspends the time keeping of the elapsed time TQ, causes the image reading device 11 to stop reading the image of the source document, and deactivates the image forming device 12, thereby cancelling the copying operation (S409). In addition, the controller 31 counts up the number of times of cancellation CN stored in the storage device 28, thereby updating the same (S410), because the image forming job has been cancelled.

Further, upon deciding that the elapsed time TQ has reached the cancellable time ΔT2 (Yes at S408), without the cancel instruction having been received (No at S407), the controller 31 suspends the time keeping of the elapsed time TQ, starts the copying operation by causing the image reading device 11 to read the image of the source document, and causes the image forming device 12 to form the image of the source document on the recording sheet (S411). In this case, since the preliminary operation of the image forming device 12 is already started at S402, the time before the image forming device 12 becomes ready to perform the image forming can be shortened.

In this embodiment, as described above, when the cancellation is accepted within the cancellable time ΔT2, the number of times of cancellation CN is counted up, and a longer cancellable time ΔT2 is set with respect to the current image forming job, when the number of times of cancellation CN in the preceding image forming jobs is larger than in the current image forming job. Therefore, when the number of times of cancellation CN is large, the user can cancel the image forming job, despite touching the cancel key K12 with a certain delay after touching the start key.

Here, although the controller 31 counts the number of times of cancellation CN accepted within the cancellable time ΔT2 in this embodiment, the controller 31 may count the number of times of cancellation CN corresponding to the number of cancel instructions received by the controller 31, after the cancellable time ΔT2 has expired, in other words the number of times of invalid cancellation CN, and set the cancellable time ΔT2, similarly to the above, so as to be longer with the increase of the number of times of invalid cancellation CN.

The operation device 22 may include, for example, a stop key for inputting an instruction to suspend the ongoing job, as one of the hard keys. When the user touches the stop key thus inputting the instruction to suspend the ongoing job, after the cancellable time ΔT2 has expired, and the controller 31 receives this instruction, the controller 31 may count the number of times of such an instruction, as the number of times of invalid cancellation CN. In this case, when the number of times of invalid cancellation CN is less than a predetermined threshold, the controller 31 sets the cancellable time ΔT2 to a predetermined time t19, and when the number of times of invalid cancellation CN is equal to or larger than the threshold, the controller 31 sets the cancellable time ΔT2 is set to a predetermined time t21, longer than the predetermined time t19. Alternatively, the controller 31 may store a plurality of predetermined thresholds, and when the number of times of invalid cancellation CN is equal to or larger than one of the thresholds, the cancellable time ΔT2 may be set to a time t associated with the largest threshold, among the thresholds less than the number of times of invalid cancellation CN. Thus, the cancellable time ΔT2 can be set to be longer, when the number of times of invalid cancellation CN is larger (i.e., the cancellable time ΔT2 is shortened when the number of times of invalid cancellation CN is less). Here, with respect to each of the thresholds, a longer time is associated with a larger threshold.

The disclosure may be modified in various manners, without limitation to the foregoing embodiment. Further, the configurations and processings described with reference to FIG. 1 to FIG. 10 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a recording sheet;
an operation device that receives an instruction inputted by a user; and
a control device that sets a cancellable time upon receipt, via the operation device, of a start instruction to cause the image forming device to start image forming, causes the image forming device to start the image forming, in a case where a cancel instruction to cancel the image forming is not received within the cancellable time via the operation device, and cancels the image forming in a case where the cancel instruction is received within the cancellable time, via the operation device,
wherein the control device changes the cancellable time, according to a predetermined condition.

2. The image forming apparatus according to claim 1, further comprising a display device,
wherein the control device causes the display device, upon receipt of the start instruction via the operation device, to display a confirmation screen showing information about the image forming, and changes the cancellable time according to the predetermined condition, specified so as to set the cancellable time to the longer time, the shorter a period of time is, from a time point at which the start instruction was received, to a time point at which a confirmation notice, notifying that the information displayed on the confirmation screen has been confirmed, has been received via the operation device, and
the cancellable time corresponds to an elapsed time from the time point at which the confirmation notice has been received.

3. The image forming apparatus according to claim 2,
wherein the control device causes the display device to display, during the cancellable time, a message to an effect that the image forming can be cancelled.

4. The image forming apparatus according to claim 1, further comprising an image pickup device that shoots an image of the user's face,
wherein the control device estimates an age of the user on a basis of the image of the user's face that has been shot, and changes the cancellable time according to the predetermined condition, specified so as to set the cancellable time to the longer time, the higher the estimated user's age is.

5. The image forming apparatus according to claim 1, further comprising a card reader that reads an age of the user from an ID card of the user,
wherein the control device changes the cancellable time according to the predetermined condition, specified so as to set the cancellable time to the longer time, the higher the user's age read by the card reader from the ID card is.

6. The image forming apparatus according to claim 1, further comprising a billing device that charges a fee for the image forming,
wherein the control device changes the cancellable time according to the predetermined condition, specified so as to set the cancellable time to the longer time, the higher the fee charged by the billing device is.

7. The image forming apparatus according to claim 1,
wherein the control device counts up a number of times of cancellation, when the cancel instruction is received via the operation device before the cancellable time expires, and changes the cancellable time according to the predetermined condition, specified so as to set, when start of a next image forming is instructed, the cancellable time to the longer time, the larger the counted number of times of cancellation is.

8. The image forming apparatus according to claim 1,
wherein the control device decides that the cancel instruction is invalid, when the cancel instruction is received via the operation device after the cancellable time has expired, counts up a number of times of invalid cancellation, and changes the cancellable time according to the predetermined condition, specified so as to set, when start of a next image forming is instructed, the cancellable time to the longer time, the larger the counted number of times of invalid cancellation is.

9. The image forming apparatus according to claim 4, further comprising a display device,
wherein the control device causes the display device to display, during the cancellable time, a message to an effect that the image forming can be cancelled.

10. The image forming apparatus according to claim 1,
wherein the control device causes the image forming device to start a predetermined preliminary operation, at a time point at which the start instruction has been received by the operation device.
